(19) United States
(12) Patent Application Publication
(10) Pub. No.: US 2021/0272013 A1
(43) Pub. Date: Sep. 2, 2021

(54) CONCEPT MODELING SYSTEM

(71) Applicant: S&P Global, New York, NY (US)

(72) Inventor: Aron Szanto, New York, NY (US)

(21) Appl. No.: 16/803,777

(22) Filed: Feb. 27, 2020

(51) Int. Cl. G06N 20/00; G06Q 10/10; G06F 40/30; G06F 40/279; G06F 40/247

(52) U.S. Cl. CPC G06N 20/00; G06Q 10/10; G06F 40/247; G06F 40/279; G06F 40/30

(57) ABSTRACT

Training an artificial intelligence model to determine whether a text document is written about a particular concept. A set of key terms that relate to the particular concept for which training of the artificial intelligence model is of interest is identified. The set of key terms is expanded into a key term superset comprising terms that include the set of key terms and a number of additional terms that have meanings related to a number of key terms in the set of key terms. Candidate documents having a selected likelihood of being relevant to the concept using the terms in the key term superset are identified based on an occurrence of the terms in the candidate documents. Training documents are generated from the candidate documents and unlabeled documents in which the unlabeled documents have not been selected based on the unlabeled documents having a likelihood of being relevant to the concept.

### BACKGROUND INFORMATION

### 1. Field

The present disclosure relates generally to an improved system and method, which can be embodied in an apparatus, computer system, or computer program product, for training an artificial intelligence model to recognize a concept in a selection of text.

### 2. Background

Artificial intelligence models can be used for many different purposes. For example, artificial intelligence models can be used in image recognition, pattern recognition, voice analysis, manufacturing processes, content analysis, natural language understanding, and for other suitable purposes. With content analysis, artificial intelligence models can be used to analyze documents to obtain an understanding of the contents in the documents. For example, artificial intelligence models can be trained to determine whether a particular concept is present in a document. A concept is present in a document when the text of the document is written about or relates to the concept.

Artificial intelligence models are trained using machine learning techniques. An artificial intelligence model can be trained to determine whether a text document is about a particular concept. The type of training to recognize concepts in documents can be more expensive and time-consuming than desired. A concept is a topic that can be a primary theme of text in a document. Quality of an artificial intelligence model relies on the quality and size of the documents used in a training dataset used to train the artificial intelligence model. As the number of documents used in a training dataset increases, the artificial intelligence model trained with the training dataset has a higher quality because the artificial intelligence model has more information to process during training. Each document in the training dataset can be associated with a label Indicating how relevant the document in the training dataset is to the concept.

Currently, curating these training sets is labor-intensive. This process for selecting and processing documents for training datasets is a manual process and involves humans having being required to read hundreds or thousands of documents and label each document as “positive” or “negative” with respect to a concept. A label can be used to mark a document as “positive” or “negative”.

Creating training datasets involves accessing and using larger amounts of resources but results in training datasets that may only contain hundreds of documents. This number of documents is relatively small as compared to the effort used to create the training datasets. These relatively small training datasets are used to train an artificial intelligence model. The training can occur by applying the artificial intelligence model to/against each document in the training datasets and comparing the predictions made by the artificial intelligence model to the human-assigned labels, then determining the error or differences between the respective predictions and labels. Further, the training can include improving the artificial intelligence model by updating the artificial intelligence model in accordance with the mistakes that it made. The running and updating of steps can be repeated until the accuracy for the artificial intelligence model has reached a desired level or does not improve further.

The large amount of resources required to train a single concept model using the current training approach makes it impractical to train artificial intelligence models for numerous concepts, because each model requires its own independently-curated dataset. As a result, the range of concepts that can be recognized for use in wide-ranging applications for users can be more limited than desired.

Therefore, it would be desirable to have a method and apparatus that take into account at least some of the issues discussed above, as well as other possible issues. For example, it would be desirable to have a method and apparatus that overcome a technical problem with the large amount of resources used in training artificial intelligence models that are able to recognize concepts.

### SUMMARY

An embodiment of the present disclosure provides a concept recognition system comprising a computer system and a concept modeling engine in the computer system. The concept modeling engine operates to identify a set of key terms that relate to a concept for which training of an artificial intelligence model is of interest. The concept modeling engine operates to expand the set of key terms into a key term superset comprising terms that include the set of key terms and a number of additional terms that have meanings related to a number of key terms in the set of key terms. The concept modeling engine operates to identify candidate documents that have a selected likelihood of being relevant to the concept using the terms in the key term superset based on an occurrence of the terms in the candidate documents. The concept modeling engine operates to generate training documents from the candidate documents and from unlabeled documents in which the unlabeled documents have not been selected based on the unlabeled documents having a likelihood of being relevant to the concept.

Another embodiment of the present disclosure provides a method for training an artificial intelligence model. A set of key terms that relate to a concept for which training of the artificial intelligence model is of interest is identified. The set of key terms is expanded into a key term superset comprising terms that include the set of key terms and a number of additional terms that have meanings related to a number of key terms in the set of key terms. Candidate documents that have a selected likelihood of being relevant to the concept using the terms in the key term superset are identified based on an occurrence of the terms in the candidate documents. Training documents are generated from the candidate documents and from unlabeled documents in which the unlabeled documents have not been selected based on the unlabeled documents having a likelihood of being relevant to the concept, wherein time is reduced in training the artificial intelligence model to identify documents relating to the concept with the computer system generating the training documents.

Still another embodiment of the present disclosure provides a method for training an artificial intelligence model. A set of key terms that relate to a concept for which training of the artificial intelligence model is of interest is identified. The set of key terms is expanded into a key term superset comprising terms that include the set of key terms and number of additional terms that have meanings related to a number of key terms in the set of key terms. A collection of documents is searched using the terms in the key term superset to identify unlabeled documents in which the unlabeled documents have not been selected based on the unlabeled documents having a likelihood of being relevant to the concept. Training documents from the unlabeled documents are generated using a machine learning model. The training documents comprise a positive sample and a negative sample, wherein the positive sample comprises documents in the unlabeled documents that have been prioritized based on a presence of terms in the documents and the negative sample comprises a random sampling of unlabeled documents from the collection of documents. The method enables reducing the time in training artificial intelligence model to identify a document relating to the concept using the training documents.

Another embodiment of the present disclosure provides a concept recognition system comprising a computer system that operates to identify a set of key terms that relate to a concept for which training of the artificial intelligence model is of interest. The computer system operates to expand the set of key terms into a key term superset comprising terms that include the set of key terms and a number of additional terms that have meanings related to a number of key terms in the set of key terms. The computer system also operates to search the collection of documents using the terms in the key term superset to identify unlabeled documents in which the unlabeled documents that have not been selected based on the unlabeled documents having a likelihood of being relevant to the concept. The computer system operates to generate training documents from the unlabeled documents using a machine learning model, wherein the training documents comprises a positive sample and a negative sample, wherein the positive sample comprises documents in the unlabeled documents that have been prioritized based on a presence of terms in the documents and the negative sample comprises a random sampling of unlabeled documents from the collection of documents. The concept recognition system enables reducing the time in training the artificial intelligence model to identify documents relating to the concept with the computer system generating the training documents.

Still another embodiment of the present disclosure provides a computer program product for training an artificial intelligence model, the computer program product comprising a computer readable storage media with first program code, second program code, third program code, and fourth program code stored on the computer-readable storage media. The first program code is executed to identify a set of key terms that relate to a concept for which training of the artificial intelligence model is of interest. The second program code is executed to expand the set of key terms into a key term superset comprising terms that include the set of key terms and a number of additional terms that have meanings related to a number of key terms in the set of key terms. The third program code is executed to identify candidate documents that have a selected likelihood of being relevant to the concept using the terms in the key term superset based on an occurrence of the terms in the candidate documents. The fourth program code is executed to generate training documents from the candidate documents and from unlabeled documents in which the unlabeled documents have not been selected based on the unlabeled documents having a likelihood of being relevant to the concept. Time is reduced in training the artificial intelligence model to identify documents relating to the concept with the computer system generating the training documents.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a concept training environment in accordance with an illustrative embodiment;

FIG. 3 is a data flow diagram illustrating a data flow used to train an artificial intelligence model to recognize a concept in accordance with an illustrative embodiment;

FIG. 4 is a block diagram illustrating the generation of a key term superset in accordance with an illustrative embodiment;

FIG. 5 is a block diagram illustrating an instance of a generation of a training dataset in accordance with an illustrative embodiment;

FIG. 6 is a flowchart of a process for training an artificial intelligence model in accordance with an illustrative embodiment;

FIG. 7 is a flowchart of a process for identifying candidate documents in accordance with an illustrative embodiment;

FIG. 8 is a flowchart of a process for identifying candidate documents in accordance with an illustrative embodiment;

FIG. 9 is a flowchart of a process for prioritizing documents in accordance with an illustrative embodiment;

FIG. 10 is a flowchart of a process for generating training documents from candidate documents in accordance with an illustrative embodiment;

FIG. 11 is a flowchart of a process for generating training documents from candidate documents in accordance with an illustrative embodiment; and

FIG. 12 is a block diagram of a data processing system in accordance with an illustrative embodiment.

### DETAILED DESCRIPTION

The illustrative embodiments recognize and take into account one or more different considerations. For example, the illustrative embodiments recognize and take into account that training artificial intelligence models to reach desired levels of accuracy can take more time than desired. The illustrative embodiments recognize and take into account that currently, creating training datasets of documents to train an artificial intelligence model to recognize concepts is labor-intensive. The illustrative embodiments recognize and take into account that the process for selecting and processing documents for training datasets is a manual process and involves humans having to read hundreds or thousands of documents and label each document as “positive” or “negative” with respect to a concept.

Further, the illustrative embodiments recognize and take into account the fact that the limited size of the training datasets can make it difficult for artificial intelligence models to be trained to a higher level of accuracy in recognizing concepts, because the use of a smaller dataset may provide lower accuracy levels. The illustrative embodiments recognize and take into account that, with the limited size of training datasets, a higher accuracy may not be reached.

The illustrative embodiments also recognize and take into account that it would be desirable to reduce or eliminate the need for human intervention in creating training datasets for training an artificial intelligence model to recognize the concept. Thus, the illustrative embodiments provide a method, apparatus, system, and computer program product for automatically training an artificial intelligence model to recognize a concept in a text document. An illustrative example described herein provides an automated process for creating training datasets. With this automation, the amount of human labor needed to create the training datasets can be reduced or eliminated using an illustrative example.

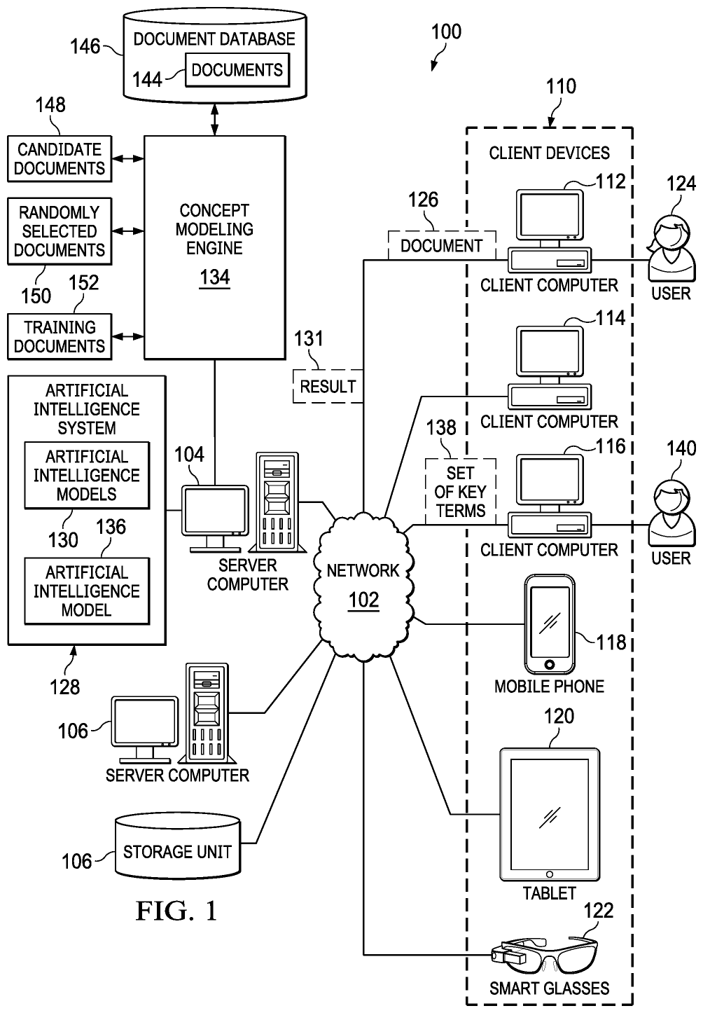

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, user 124 at client computer 112 can send document 126 for analysis to artificial intelligence system 128 running on server computer 104. In this illustrative example, artificial intelligence system 128 comprises artificial intelligence models 130 that have been trained to identify concepts. As depicted, each of artificial intelligence models 130 can be trained to identify a single concept. In other illustrative examples, an artificial intelligence model can identify more than one concept.

As depicted, artificial intelligence system 128 can return result 131 to client computer 112 in response to receiving a request to analyze document 126. Result 131 contains the concept identified for document 126.

In this illustrative example, concept modeling engine 134 is located in server computer 104. As depicted, concept modeling engine 134 operates to train artificial intelligence models 136 in artificial intelligence system 128 to recognize a concept.

Concept modeling engine 134 receives a set of key terms 138 for a concept of interest. In this illustrative example, the set of key terms 138 is received from user 140 operating client computer 116.

In response to receiving the set of key terms 138, concept modeling engine 134 can expand the set of key terms 138 into a key term superset. The key term superset can comprise the set of key terms 138 and additional terms and meanings related to the set of key terms 138. These additional terms can be, for example, synonyms, alias, or other words or phrases that have meanings related to a number of key terms in the set of key terms 138.

In this illustrative example, the key term superset is used to select documents 144 in document database 146 for use in training artificial intelligence model 136. Documents 144 in document database 146 are documents that are unlabeled and can be potentially relevant to the concept selected for training.

The key term superset can be used to select documents 144 on a breadth first basis and a depth first basis. Breadth first prioritizes documents based on how many keywords are mentioned in the documents. Depth first prioritizes documents based on how many times each key term is mentioned. Concept modeling engine 134 identifies candidate documents 148 from documents 144 that have been prioritized on a breadth first basis and a depth first basis based on a threshold or level of priority to form candidate documents 148.

In this illustrative example, candidate documents 148 have been processed from training data in the form of training documents 152 instead of using manual human classification. As depicted, training documents 152 include a positive sample and a negative sample. In the illustrative example, the positive sample in training documents 152 and the negative sample in training documents 152 are labeled to indicate whether the document is positive or negative with respect to the concept. The label can be a bit that is associated with each document with a “1” indicating a positive document in the positive sample and a “0” indicating a negative document in the negative sample.

Concept modeling engine 134 combines candidate documents 148 with randomly selected documents 150 from document database 146. Randomly selected documents 150 are documents in document database 146 that have not been selected based on the unlabeled documents having a likelihood of low/little relevance to the concept of interest.

Concept modeling engine 134 uses these combined documents as training documents 152 to train artificial intelligence model 136. In this illustrative example, the training of artificial intelligence model 136 creates a text classifier. Once trained, artificial intelligence model 136 can be added to artificial intelligence models 130 in artificial intelligence system 128 for use in providing services in analyzing documents 144. As a result, a service for classifying documents can be performed using a text classifier trained using training documents 152.

In the illustrative example in this figure, the size of training documents in training datasets can be very large when created by concept modeling engine 134 as compared to those created using human labor. For example, training documents 152 in a training data set can have tens of thousands, hundreds of thousands, or millions of documents as compared to a few hundred documents selected using human labor.

Further, a time reduction is present in training artificial intelligence model 136 in the illustrative example. For example, the processing of documents to create training datasets with documents such as training documents 152 can be performed more quickly as compared to current techniques using human labor. For example, tagging documents for training datasets and training artificial intelligence models 130 can be performed in seconds or minutes in the illustrative example as compared to hours or days using human labor.

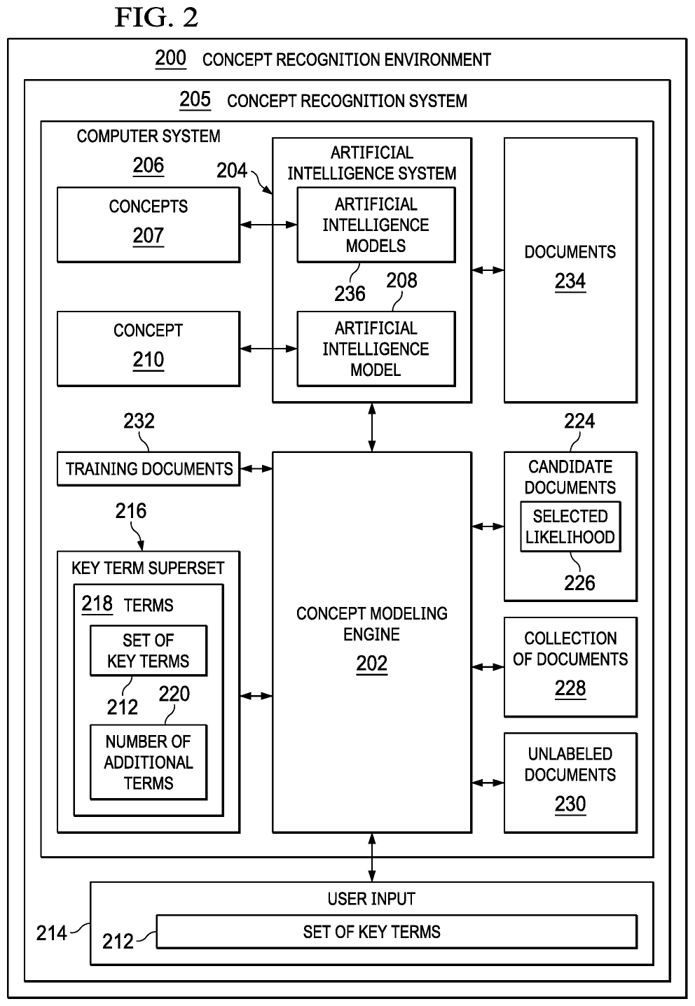

With reference now to FIG. 2, a block diagram of a concept training environment is depicted in accordance with an illustrative embodiment. In this illustrative example, concept recognition environment 200 includes components that can be implemented in hardware such as the hardware shown in network data processing system 100 in FIG. 1.

As depicted, concept recognition environment 200 is an environment in which concept modeling engine 202 manages artificial intelligence system 204 in computer system 206 to provide services for analyzing documents to identify concepts 207.

Computer system 206 is a physical hardware system and includes one or more data processing systems. When more than one data processing system is present in computer system 206, those data processing systems are in communication with each other using a communications medium. The communications medium may be a network. The data processing systems may be selected from at least one of a computer, a server computer, a tablet, or some other suitable data processing system.

In this illustrative example, concept modeling engine 202 and computer system 206 form concept recognition system 255. In managing artificial intelligence system 204 to provide services, concept modeling engine 202 can perform training of artificial intelligence model 208 for use in artificial intelligence system 204.

In this illustrative example, artificial intelligence model 208 can be trained to recognize concept 210 by concept modeling engine 202. Artificial intelligence model 208 comprises at least one of an artificial neural network, a cognitive system, a Bayesian network, a fuzzy logic, an expert system, a natural language system, or some other suitable system. Machine learning is used to train artificial intelligence model 208. Machine learning involves inputting data to the process and allowing the process to adjust and improve the function of artificial intelligence model 208.

Concept modeling engine 202 can be implemented in software, hardware, firmware, or a combination thereof. When software is used, the operations performed by concept modeling engine 202 can be implemented in program code configured to run on hardware, such as a processor unit. When firmware is used, the operations performed by concept modeling engine 202 can be implemented in program code and data and stored in persistent memory to run on a processor unit. When hardware is employed, the hardware may include circuits that operate to perform the operations in concept modeling engine 202.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As depicted, concept modeling engine 202 identifies a set of key terms 212 that relate to concept 210 for which training of artificial intelligence model 208 is of interest. A key term in set of key terms 212 can be a word or a phrase.

In this illustrative example, set of key terms 212 can be identified in a number of different ways. For example, concept modeling engine 202 can receive user input 214 that contains set of key terms 212. User input 214 can be generated by at least one of a human machine interface of an artificial intelligence system, an expert system, or some other suitable process.

The human machine interface comprises an input system and a display system that enables a person to interact with computer system 206.

In this illustrative example, concept modeling engine 202 expands set of key terms 212 into key term superset 216. As depicted, key term superset 216 comprises terms 218 that include set of key terms 212 and number of additional terms 220 that have meanings related to a number of key terms in set of key terms 212. Number of additional terms 220 in set of key terms 212 can be a subset or all of set of key terms 212.

As used herein, a “number of,” when used with reference to items, means one or more items. For example, a “number of additional terms 220” is one or more of additional terms 220.

In training artificial intelligence model 208, concept modeling engine 202 identifies candidate documents 224 that have been selected based on the likelihood of being relevant to concept 210 using terms 218 in key term superset 216 based on an occurrence of terms 218 in candidate documents 224. In this illustration, candidate documents 224 can be identified from collection of documents 228.

As depicted, candidate documents 224 are likely positive documents that relate to concept 210. In this illustrative example, the selected likelihood can be based on a threshold or a position of a document in a list that is prioritized as to whether a document is likely to relate to concept 210.

In this illustrative example, concept modeling engine 202 also identifies unlabeled documents 230 in collection of documents 228. Unlabeled documents 230 are documents that have not been selected based on whether these documents have a likelihood of being relevant to concept 210. In this illustrative example, unlabeled documents 230 are randomly selected.

As depicted, collection of documents 228 can be in a number of different locations. For example, collection of documents 228 can be located in at least one of a document database, a file system, or some other location. Collection of documents 228 can be stored in multiple locations.

In this illustrative example, unlabeled documents 230 are selected from collection of documents 228 and are not selected based on whether those documents are likely or not likely to relate to concept 210. Unlabeled documents 230 can be randomly selected and do not have an indication as to whether documents in unlabeled documents 230 are likely or not likely to relate to concept 210. In other words, unlabeled documents 230 have not been selected based on the unlabeled documents 230 having a likelihood of being relevant to concept 210. Whether unlabeled documents 230 have a likelihood of relevance to concept 210 is unknown. In this illustrative example, once the likelihood of a document being relevant to a concept is known, that document is no longer considered an unlabeled document.

In this illustrative example, concept modeling engine 202 generates training documents 232 from candidate documents 224 and from unlabeled documents 230 in which unlabeled documents 230 have not been selected based on unlabeled documents 230 having a likelihood of being relevant to the concept. The generating of training documents 232 can be performed as an automated process by concept modeling engine 202. With this automation, the amount of human labor needed to generate select training documents 232 for training artificial intelligence model 208 to identify documents 234 relating to concept 210 using training documents 232 can be reduced or eliminated.

Further, the number of training documents 232 can be very large when created as indicated in the illustrative example as compared to those created using human labor. For example, the number of training documents 232 can have tens of thousands, hundreds of thousands, or millions of documents as compared to a few hundred documents selected using human labor.

When artificial intelligence model 208 is trained, artificial intelligence model 208 can be added to artificial intelligence models 236 in artificial intelligence system 204. Artificial intelligence models 236 in artificial intelligence system 204 are artificial intelligence models that have been trained to recognize concepts 207 in documents 234 that are received for analysis. In some illustrative examples, artificial intelligence system 204 can also include hardware such as a computer system that includes one or more data processing systems.

Further, in the illustrative example, concept modeling engine 202 can use supervised machine learning to train artificial intelligence model 208 as compared to current techniques that use unsupervised machine learning. With the use of supervised machine learning, increased accuracy and performance can be achieved when training artificial intelligence model 208.

For example, the quality of artificial intelligence models is quantifiable in supervised machine learning using standard metrics, such as accuracy. In contrast, the quality of models in unsupervised learning with current techniques is more difficult to evaluate objectively. Although some human resources are used with supervised machine learning to train artificial intelligence model 208, the amount of human resources employed is much less as compared to the human resources used to generate training with current techniques.

Further, with the use of supervised machine learning by concept modeling engine 202 to train artificial intelligence model 206, the predictions made by artificial intelligence model 206 trained using this type of machine learning can be explainable, interpretable, or both. For example, artificial intelligence model 206 trained using supervised machine learning can provide an answer to a question and can also provide an explanation as to why artificial intelligence model 206 arrived at that answer. This ability to explain and interpret the predictions is a useful consideration when using artificial intelligence model 206 in a product.

Additionally, artificial intelligence models 236 trained by concept modeling engine 202 using supervised machine learning tend to provide predictions that better align with human understandings of problems, while other artificial intelligence models trained using unsupervised machine learning models may not arrive at solutions that make sense to human observers.

In the illustrative example, artificial intelligence model 208 can be trained more quickly using training documents 232 in a manner selected by concept modeling engine 202 as compared to current techniques using human input. In the illustrative example, a time reduction is present in training artificial intelligence model 208. For example, the processing of documents to select training documents 232 can be performed more quickly as compared to current techniques using human labor. For example, selecting training documents 232 for training data sets and training artificial intelligence models 236 can be performed in seconds or minutes in the illustrative example as compared to hours or days using human labor with current techniques.

Training documents 232 containing candidate documents 224 and unlabeled documents 230 can result in at least one of faster or more comprehensive training of artificial intelligence model 208. Artificial intelligence model 208 has increased accuracy in identifying concept 210 as compared to other artificial intelligence models with the same amount of training time using current techniques. Further, repeated training of artificial intelligence model 208 using additional training documents can be reduced or eliminated by using training documents 232 as selected by concept modeling engine 202, as compared to manual human classification.

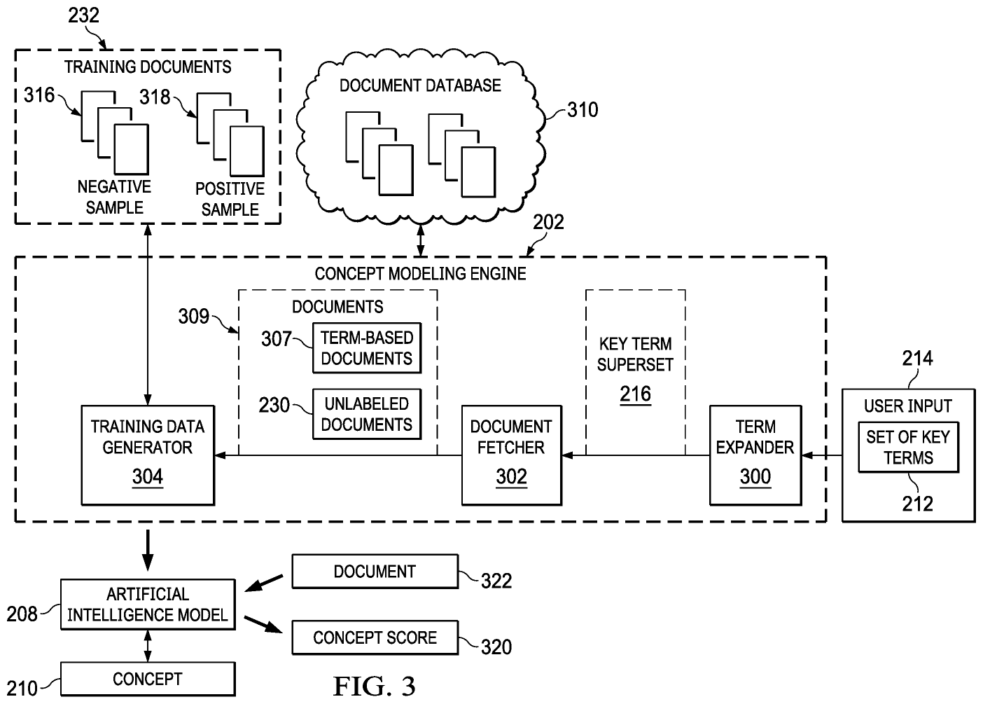

With reference next to FIG. 3, a data flow diagram illustrating data flow used to train an artificial intelligence model to recognize a concept is depicted in accordance with an illustrative embodiment. In the illustrative examples, the same reference numeral may be used in more than one figure. This reuse of a reference numeral in different figures represents the same element in the different figures.

In this illustrative example, concept modeling engine 202 includes a number of different components. As depicted, concept modeling engine 202 comprises term expander 300, document fetcher 302, and training data generator 304.

As depicted, concept modeling engine 202 operates to train artificial intelligence model 208. In this illustrative example, term expander 300 receives set of key terms 212 in user input 214. Set of key terms 212 can include keywords or phrases that are of interest. In other words, user input 214 does not have to name the concept that artificial intelligence model 208 is trained to recognize.

As depicted, term expander 300 takes the set of key terms 212 and determines the number of additional terms 220 in FIG. 2 from set of key terms 212. These additional terms can include synonyms, aliases, or other words or phrases that have meanings related to one or more key terms in set of key terms 212. These additional terms and set of key terms 212 form key term superset 216, which is sent to document fetcher 302.

In this illustrative example, document fetcher 302 queries document database 310 and retrieves documents 309 from document database 310. As depicted, term-based documents 307 in documents 309 can be retrieved from document database 310 using terms in key term superset 216.

Further, the queries made to document database 310 to retrieve documents 309 can also be made randomly without using key term superset 216. These documents in documents 309 are unlabeled documents 230. Unlabeled documents 230 have not been selected based on the relevance of these documents to the concept.

Document fetcher 302 sends term-based documents 307 and unlabeled documents 230 in documents 309 to training data generator 304. In this illustrative example, training data generator 304 prioritizes term-based documents 307 to form candidate documents 224. Training data generator 304 prioritizes term-based documents 307 on a breadth first basis and on a depth first basis. Breadth first prioritizes term-based documents 307 based on how many different key terms are present in a document. Depth first prioritizes term-based documents 307 based on how many times a given keyword is mentioned in a document.

This prioritization is identified in a first list showing the order of term-based documents 309 as breadth first and a second list showing the order of term-based documents 307 as depth first. The documents higher in a list are more likely to be positive documents relevant to the concept as compared to documents lower in the list.

Training data generator 304 selects a portion of the breadth first prioritized documents in term-based documents 307 and a portion of depth first prioritized documents in term-based documents 307 to form candidate documents 224. For example, training data generator 304 can select a number of documents having the highest priority from each list of prioritized documents.

Training data generator 304 combines candidate documents 224 with unlabeled documents 230 to generate training data in the form of training documents 232. Training documents 232 are a binary labeled dataset that comprises negative sample 316 and positive sample 318. Negative sample 316 is one or more documents that are unlikely to be relevant to the concept. Positive sample 318 is one or more documents that are likely to be relevant to concept.

Training data generator 304 sends training documents 232 to artificial intelligence model 208. Artificial intelligence model 208 learns how to determine whether concept 210 is present in a document using training documents 232. After training is completed, artificial intelligence model 208 is used to process documents to determine whether concept 210 is present.

For example, artificial intelligence model 208 can receive document 322 as an input. Artificial intelligence model 208 analyzes document 322 and outputs concept score 320. Concept score 320 can indicate how likely document 322 relates to concept 210. For example, concept score 320 can be a value between zero and one in which zero indicates a 100 percent certainty that the concept is absent and one indicates a 100 percent certainty the concept is present in document 322. A value of 0.7 would indicate a 70 percent certainty that concept 210 is present in document 322. Concept score 320 can take other forms such as a value between 1 and 5, a percentage, a binary value of “0” or “1”, or some other suitable form.

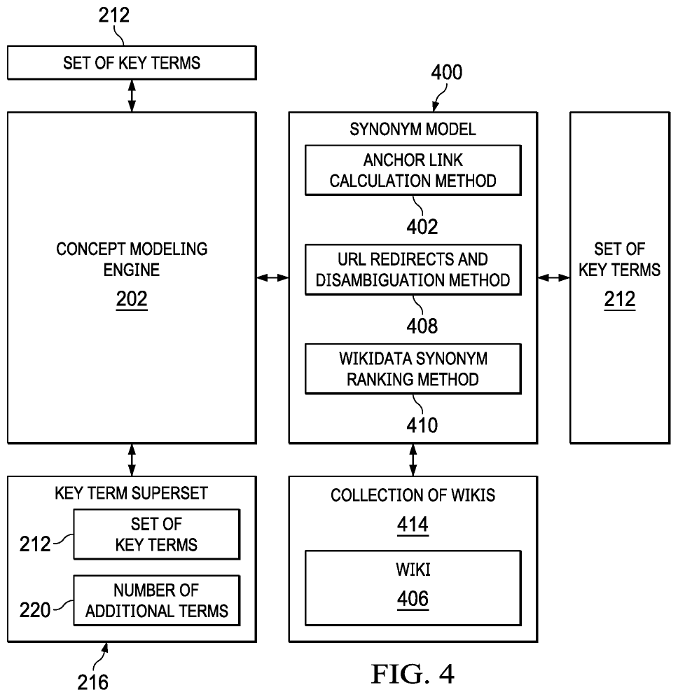

Turning now to FIG. 4, a block diagram illustrating generating a key term superset is depicted in accordance with an illustrative embodiment. As depicted, concept modeling engine 202 can expand set of key terms 212 into key term superset 216 in a number of different ways.

For example, the expansion can be performed using synonym model 400. In this illustrative example, synonym model 400 pairs or associates terms with all the ways that the term has been referred to by one or more users. As depicted, synonym model 400 is a model that maps a term to a set of terms that have the same meaning or have a meaning related to one or more terms in set of key terms 212.

In this illustrative example, the number of additional terms 220 having meanings that are related to set of key terms 212 may be synonyms or aliases. In other examples, the number of additional terms 220 may not be synonyms or aliases but still have meanings related to set of key terms 212. In one illustrative example, “computer” is a keyword, and “digital” is a related term that is not a synonym of the key term “computer”. As another example, “mining” is a keyword, and “mining industry” is a related term to the keyword “mining”. In yet another example, “taxes” is a keyword and a related term that is not a synonym is “tax policy.”

In this illustrative example, a number of additional terms 220 is obtained from synonym model 400. Synonym model 400 can take a number of different forms.

For example, synonym model 400 can include anchor link calculation method 402. With this method, anchor links in wiki 406 can be used to find terms that are synonyms or aliases or have meanings related to one or more key terms in set of key terms 212.

As depicted, wiki 406 is a knowledge base website that can be modified by users. Wiki 406 can take any form and, in this depicted example, can be, for example, Wikipedia, which is hosted by the Wikimedia Foundation. Wikipedia is a collection of summaries of knowledge from different fields located on web pages. A web page can have a plurality of terms that are linked to other web pages. For example, a term in a first web page in Wikipedia can be have a link to a second web page that provides a definition, description, or explanation of the term. The second web page can include terms that have meanings considered to be related to the term with the link in the first web page.

With anchor link calculation method 402, text for a key term can link to a certain entity, and that given link is an anchor link for interpreting various statistics and information obtainable for wiki 406. These statistics and information include, for example, at least one of a number of page views, a number of links to a page, a number of pages to which the text is linked, or other related information.

In this example, anchor link calculation method 402 recognizes the links between pages and between terms on given pages. Additionally, anchor link calculation method 402 can find synonyms and aliases by interpreting all the inline hyperlinks within a given page and instances where a given page connects back to the anchor page. Thus, anchor link calculation method 402 first sees what term is being referred to and then expands to synonyms.

As another example, synonym model 400 can also include universal resource locator (URL) redirects and disambiguation method 408. In this example, one word can mean various things. URL redirects and disambiguation method 408 accounts for this situation through the use of URLs in collection of wikis 414. Wikis 414 is more than one wiki in this example.

Collection of wikis 414 can have large amounts of information that correspond to their URLs. Using the URLs, URL redirects and disambiguation method 408 analyzes redirects, which allows URL redirects and disambiguation method 408 to determine when separate term uses are referring to the same thing. Further, in URL redirects and disambiguation method 408, the use of URL redirects enables obtaining warnings of ambiguity in a term.

As depicted, synonym model 400 can also include wikidata synonym ranking method 410. Wikidata synonym ranking method 410 obtains statistics and metainfo for wiki 406. This information is used by wikidata synonym ranking method 410 to rank synonyms. The information analyzed includes statistics, such as recency (how many people viewed, edited recently). For example, the page for Apple Inc. might have 100 times the views of “apple computers”.

The methods described in synonym model 400 in the illustrative example are only examples of some mechanisms that can be used to expand key terms and not intended to add to what techniques can be used to expand key terms. Other mechanisms can be used in addition to or in place of the ones illustrated for synonym model 400.

For example, in addition to a wiki-based mechanism, synonym model 400 also can be selected from at least one of a word embedding or other types of models that can operate to identify words or phrases that have meanings or are related to other words or phrases.

For example, a word embedding model contains words that are vectors of numbers that represent meanings of words. With this type of model, a word in set of key terms 212 is represented as a vector in a high dimensional geometric space. The process can locate words for number of additional terms 220 by finding other words nearest to the word in the high dimensional geometric space.

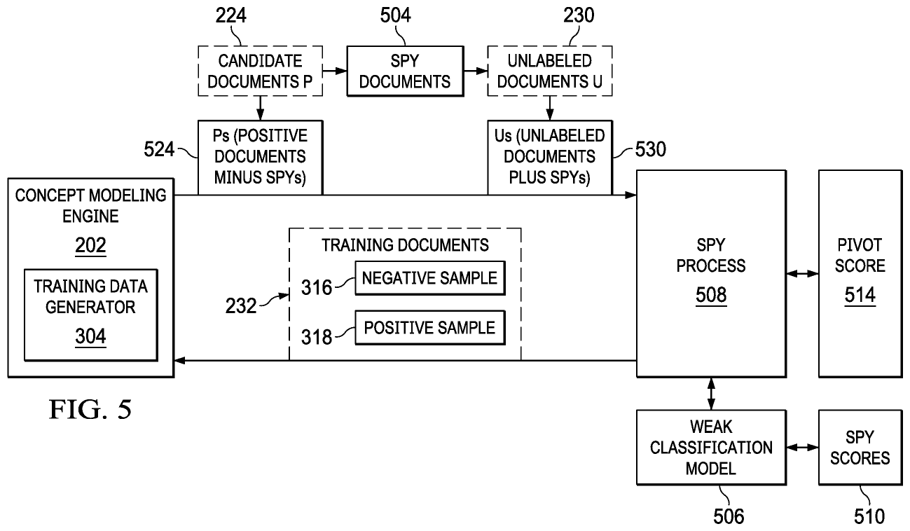

With reference next to FIG. 5, a block diagram illustrating an instance of a generation of a training dataset is depicted in accordance with an illustrative embodiment. In this illustrative example, concept modeling engine 202 generates training documents 232 using candidate documents 224 and unlabeled documents 230. The process of selecting candidate documents 224 and unlabeled documents 230 can be performed using training data generator 304 in concept modeling engine 202. In this example, training data generator 304 in concept modeling engine 202 collects likely positive documents (P) using breadth first and depth first keyword searches. These likely positive documents are referred to as candidate documents (P) 224 in this example. Training data generator 304 also selects at random a number of documents from a large document database. A large document database is a database that has a number of documents that is sufficiently large to be representative of many different content types (news articles, press releases, etc.) across a wide date range. The content types can be, for example, news articles, press releases, technical papers, white papers, and other suitable types of documents. The size of a large document database is such that every article in the database cannot reasonably be considered. As a result, a sample of the documents can be made with a greater likelihood/probability that the sample is representative of the different types of contents and dates in the database. A large document database can include, for example, tens of millions, hundreds of millions, or thousands of millions of documents. These randomly selected documents are unlabeled documents (U) 230. The randomly selected documents are referred to as unlabeled documents (U) 230 because whether these documents are related to concept 210 or not is unknown.

A small number of documents from candidate documents (P) 224 is sampled randomly and combined with unlabeled documents (U) 230. These documents are referred to as SPY documents 504. In this illustrative example, a small number of documents can be, for example, 1 percent to 20 percent of the positive documents. In this illustrative example, the set of positive documents (P) minus the SPY documents 504 is called Pₛ 524, and the set of unlabeled documents (U) plus the SPY documents 504 is called Uₛ 530.

As depicted, SPY process 508 is then initiated. The inputs to SPY process 508 from training data generator 304 are the likely positive documents, Pₛ 524, Uₛ 530. The goal of SPY process 508 is to turn candidate documents (P) 224 and unlabeled documents (U) 230 into a set of reliably positive documents and a set of reliably negative documents, each of which contains documents which has a high confidence of being related and unrelated to concept 210, respectively. The reliably positive documents are positive sample 318, and the reliable negative documents are negative sample 316 in this illustrative example.

As depicted, the SPY technique implemented in SPY process 508 involves training weak classification model 506 on Pₛ 524 and Uₛ 530 as positive sample 318 and negative sample 316, respectively, in training documents 232. In this illustrative example, weak classification model 506 is a type of machine learning model, which is a specific type of artificial intelligence model.

In this illustrative example, the purpose is to observe the predictions the weak model makes about the documents in Uₛ 530 that are known to be SPY documents. In the illustrative example, a supervised naive Bayes (NB) model is trained. In other illustrative examples, other types of models can be used as weak classification model 506. This classifier is then used to predict the probability that each document in Pₛ 524 and Uₛ 530 is relevant to concept 210.

In this example, the probabilistic prediction that weak classification model 506 emits for a given document is P[i]. This prediction for a document is called a SPY score.

In the illustrative example, a scoring threshold L is selected between 0 and 1. SPY process 508 collects all of SPY documents 504 known to be in Uₛ 530 and obtains SPY scores 510 for these documents. SPY documents 504 are then sorted in order of their SPY scores 510. SPY process 508 then chooses the L-th quantile SPY document by its SPY score. For example, if L=0.5, then SPY process 508 chooses the median-scoring document. As another example, if L=0.1, SPY process 508 chooses the SPY document that has a score higher than 10% of all SPY documents 504. This SPY document with a SPY score at the L-th quantile is called a pivot document. The SPY score associated with the pivot document is pivot score 514.

SPY process 508 can now construct the final reliably positive (RP) and reliably negative (RN) set for training documents 232. The reliably positive documents (RP) are positive sample 318 in training documents 232. The documents selected to form positive sample 318 are all documents in candidate documents (P) 224 whose SPY score is greater than pivot score 514. To form negative sample 316, SPY process 508 selects documents in unlabeled documents (U) 230 whose SPY score is less than pivot score 510. In this illustrative example, only one document will have the exact pivot score and all documents above that pivot score are considered to be reliably positive. As depicted, the threshold score T is chosen such that a selected proportion L of SPY documents are scored by the initial model to have scores under the threshold score T. In this illustrative example, the threshold score T is chosen such that the initial model is allowed to make some mistakes by misclassifying the SPY documents. Those candidate documents with scores above the threshold score T become positive documents in positive sample 318, and those unlabeled documents with scores below threshold score T become the negative documents in negative sample 316.

In one illustrative example, one or more technical solutions are present that overcome a technical problem with the large amount of resources used in training artificial intelligence models to recognize concepts. As a result, one or more technical solutions can provide a technical effect of automatically selecting documents and processing those documents to generate training documents using fewer human resources as compared to current techniques. One or more technical solutions can reduce or eliminate the need for user input to select and categorize documents as being positive or negative for a concept in generating training documents.

One or more technical solutions can also generate training datasets with larger amounts of documents than what is currently practical when training large numbers of artificial intelligence models to identify concepts in documents. For example, current techniques employing humans to select documents may result in a set of 200 to 300 training documents. In contrast, concept modeling engine 202 can be used to select a few thousand or one million or more documents for use as training documents. The selection of the greater number of documents can be performed more quickly than a human operator can generate a smaller set of training documents. The generation of these training documents for training sets can be performed with a reduction in the use of human resources as compared to current techniques.

For example, the illustrative examples create sets of training documents training artificial intelligence models in less time as compared to current techniques. For example, the generation of a set of training documents and training of an artificial intelligence model using the training documents can be performed in seconds or minutes in the illustrative examples rather than hours or days using current techniques. The time savings can be magnified when selecting training documents to train 10,000 artificial intelligence models to recognize 10,000 different concepts. As a result, an artificial intelligence system can be generated with artificial intelligence models that that provide a wider scope in analyzing documents to determine whether selected concepts are present in the documents.

Further, in the illustrative example, the accuracy of artificial intelligence models 236 in artificial intelligence system 204 can be improved when using concept modeling engine 202 to generate training documents 232 and train artificial intelligence models 236. This increased accuracy in artificial intelligence models 236 can occur through the ability to use larger numbers of training documents 232 generated by concept modeling engine 202 as compared to the number of training documents used by current techniques.

Computer system 206 can be configured to perform at least one of the steps, operations, or actions described in the different illustrative examples using software, hardware, firmware, or a combination thereof. As a result, computer system 206 operates as a special purpose computer system in which concept modeling engine 202 in computer system 206 enables training artificial intelligence models in an automated manner in response to receiving key terms for a concept of interest. In particular, concept modeling engine 202 transforms computer system 206 into a special purpose computer system as compared to currently available general computer systems that do not have concept modeling engine 202.

In the illustrative example, the use of concept modeling engine 202 in computer system 206 integrates processes into a practical application for training an artificial intelligence model to recognize a concept that increases the performance of computer system 206 in recognizing concepts 207 using artificial intelligence models 236 using concept modeling engine 202 to select training documents 232. Further, the amount of human labor can be reduced.

Artificial intelligence models 236 trained using training documents 232 can result in artificial intelligence models 236 that are more accurate in identifying concepts 207 as compared to currently available artificial intelligence models. In the illustrative example, the accuracy can increase because the size of a number of training documents 232 in the training data sets can be much larger as compared to current techniques' sets.

Further, the processes used by concept modeling engine 202 to select training documents 232 for training data sets can be implemented using machine learning models to generate training documents 232 such that the resulting training datasets can be used to train artificial intelligence models 236 that are more accurate as compared to other currently available techniques. A machine learning model is a specific type of artificial intelligence model. The selection of training documents can be performed with other types of artificial intelligence models in other examples. This increase in accuracy can occur through availability of more data in the form of a larger number of training documents 232 in training datasets as compared to current techniques.

In other words, concept modeling engine 202 in computer system 206 is directed to a practical application of processes integrated into concept modeling engine 202 in computer system 206 that identifies a set of key terms that relate to a concept.

For example, concept modeling engine 202 expands a set of key terms into a key term superset. Concept modeling engine 202 generates training documents from candidate documents and unlabeled documents using the key term superset.

The illustration of concept recognition environment 200 in FIGS. 2-5 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

The illustrative example can be applied to creating training documents for many different concepts. These training documents can be used to train artificial intelligence models such that each artificial intelligence model recognizes a particular concept. As a result, artificial intelligence models can be trained for use in artificial intelligence system 128 in FIG. 1 to provide services in processing documents from various users.

Further, concept modeling engine 202 can be applied to automatically generate an artificial intelligence model to recognize a concept for each entity in a knowledge graph or knowledge base. For example, concept modeling engine 202 can be used to train artificial intelligence models that recognize concepts for Wikipedia pages or other pages in different Wikimedia websites. Each artificial intelligence model is trained to recognize a concept for a Wikipedia page or other page in different Wikimedia websites. For example, other collections of documents or information can be used in addition to or in place of a Wikipedia or wiki.

For example, an artificial intelligence model can be trained for each of the top 10,000 pages on Wikipedia. In this illustrative example, each page has a set of aliases that can be used as the concept keywords.

As a further extension, the wiki knowledge graph provides relationships between each of the pages, providing a natural way to link related concepts.

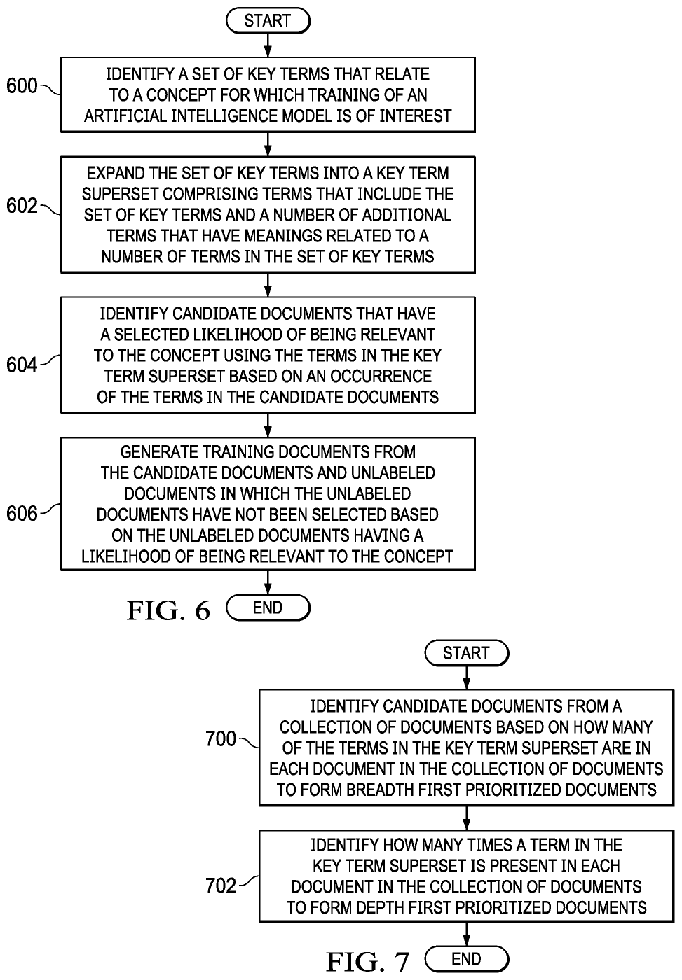

Turning next to FIG. 6, a flowchart of a process for training an artificial intelligence model is depicted in accordance with an illustrative embodiment. The process in FIG. 6 can be implemented in hardware, software, or both. When implemented in software, the process can take the form of program code that is run by one or more processor units located in one or more hardware devices in one or more computer systems. For example, the process can be implemented in concept modeling engine 202 in computer system 206 in FIG. 2.

The process begins by identifying a set of key terms that relate to a concept for which training of an artificial intelligence model is of interest (step 600). In step 600, the set of key terms can be identified by receiving the set of key terms in a user input generated by at least one of a human machine interface or an artificial intelligence system.

The process expands the set of key terms into a key term superset comprising terms that includes the set of key terms and a number of additional terms that have meanings related to a number of key terms in the set of key terms (step 602). In step 602, the set of key terms can be expanded using a synonym model. The key term superset comprises the set of key terms and the number of additional terms that have meanings related to the number of key terms in the set of key terms that are obtained from the synonym model. The synonym model can comprise at least one of an anchor link method, a URL redirects and disambiguation method, a wikidata synonym ranking method, a word embedding, or some other suitable mechanism.

The process identifies candidate documents that have a selected likelihood of being relevant to the concept using the terms in the key term superset based on an occurrence of the terms in the candidate documents (step 604). The process generates training documents from the candidate documents and unlabeled documents in which the unlabeled documents have not been selected based on the unlabeled documents having a likelihood of being relevant to the concept (step 606), with the process terminating thereafter. With this process, a use of human resources is reduced in training the artificial intelligence model to identify documents relating to the concept using the training documents. Further, the number of training documents generated using this process is much greater as compared to current techniques which rely on human resources.

Turning next to FIG. 7, a flowchart of a process for identifying candidate documents is depicted in accordance with an illustrative embodiment. The process in FIG. 7 is an example of one manner in which step 604 in FIG. 6 can be implemented.

The process begins by identifying candidate documents from a collection of documents based on how many terms in a key term superset are in each document in a collection of documents to form breadth first prioritized documents (step 700). The process identifies how many times a term in the key term superset is present in each document in the collection of documents to form depth first prioritized documents (step 702). The process terminates thereafter.

The prioritization on breadth first basis and depth first basis can be made using a threshold to select candidate documents that are used from the breadth first prioritized documents and the depth first prioritized documents. For example, a first threshold can be used for the breadth first prioritized documents, and a second threshold can be used for the depth first prioritized documents. The threshold can be used to select which documents that are breadth first prioritized and depth first prioritized are used as candidate documents. The first threshold can be the same or different from the second threshold. In this example, a document in the collection of documents can be in both a breadth first list and a depth first list.

Step 700 and step 702 can be performed in a number of different ways. For example, queries can be made to a database. A first query can be made based on breadth and a second query can be made based on depth to receive two sets of results. The same document can be returned in results from both queries.

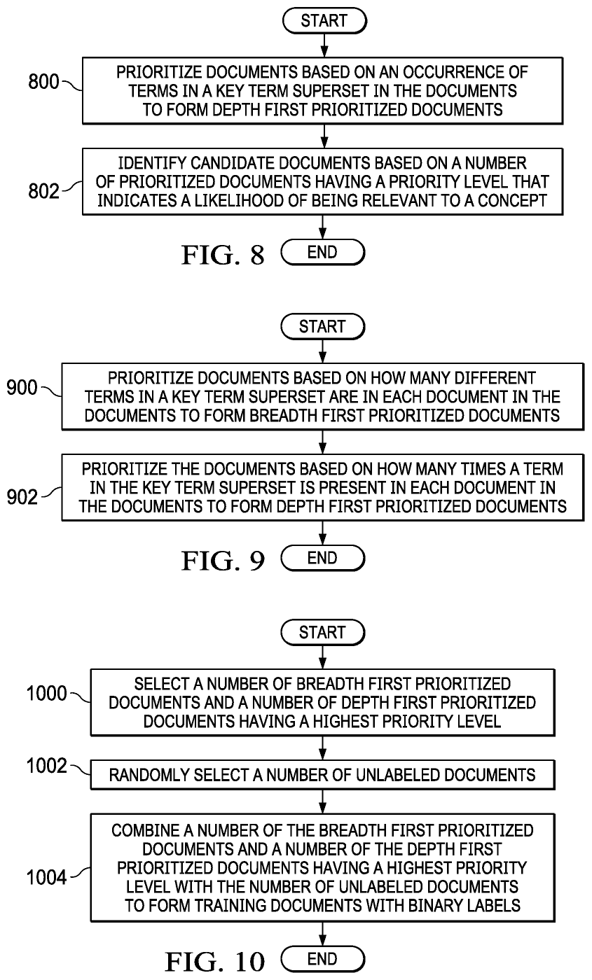

With reference to FIG. 8, a flowchart of a process for identifying candidate documents is depicted in accordance with an illustrative embodiment. The process in FIG. 8 is an example of one manner in which step 604 in FIG. 6 can be implemented.

The process begins by prioritizing documents based on an occurrence of terms in a key term superset in the documents to form depth first prioritized documents (step 800). The process identifies candidate documents based on a number of prioritized documents having a priority level that indicates a likelihood of being relevant to a concept (step 802). The process terminates thereafter.

The priority level that indicates a likelihood of relevance to the concept can take a number of different forms. For example, the top “n” scores or the top “p” percentage scores can be used to select the candidate documents. As another example, the prioritized documents can have a priority level that is selected by accepted documents that have the range of terms, such as between x terms and y terms. The prioritized documents can also be selected based on other factors such as accepting selected types of characters such as Endling or Latin script. A filter can be performed to remove selected identifiers such as email addresses, URLs, dates, and company names. This filtering can be used to normalize the text.

Turning to FIG. 9, a flowchart of a process for prioritizing documents is depicted in accordance with an illustrative embodiment. The process in FIG. 9 is an example of one manner in which step 800 in FIG. 8 can be implemented.

The process begins by prioritizing documents based on how many different terms in a key term superset are in each document in the documents to form breadth first prioritized documents (step 900). The process prioritizes the documents based on how many times a term in the key term superset is present in each document in the documents to form depth first prioritized documents (step 902). The process terminates thereafter. In this process, the documents having a higher priority have a higher likelihood of being relevant to the concept as compared to the documents having a lower priority.

In FIG. 10, a flowchart of a process for generating training documents from candidate documents is depicted in accordance with an illustrative embodiment. The process in FIG. 10 is an example of one manner in which step 606 in FIG. 6 can be implemented.

The process begins by selecting a number of breadth first prioritized documents and a number of depth first prioritized documents having a highest priority level (step 1000). The process randomly selects a number of unlabeled documents (step 1002). In this example, a document in the number of breadth first prioritized documents is also in the number of the depth first prioritized documents.

The process combines a number of the breadth first prioritized documents and the number of the depth first prioritized documents having the highest priority level with the number of unlabeled documents to form training documents with binary labels (step 1004). The process terminates thereafter.

In the process depicted in FIG. 10, step 1004 can be performed using a set of machine learning algorithms. The set of machine learning algorithms can be selected from at least one of a set of machine learning algorithms comprising at least one of an Expectation-Maximization algorithm, a Spy algorithm, a partially supervised classifier, a weakly supervised classifier, a semi-supervised classifier, a positive-unlabeled classifier, a bag-of-words model, a term frequency model-inverse document frequency (tf-idf) vectorization, a Naive Bayes classifier, a Complement Naive Bayes classifier, a Logistic Regression classifier, an artificial neural network classifier, a random forest classifier, a support vector machine classifier, a distributed word embedding, or some other suitable machine learning algorithm.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, although step 700 and step 702 are shown in a particular order, the order is not limited as shown. For example, step 700 and step 702 can be performed in reverse order. In other examples, step 700 and step 702 can be performed in parallel.

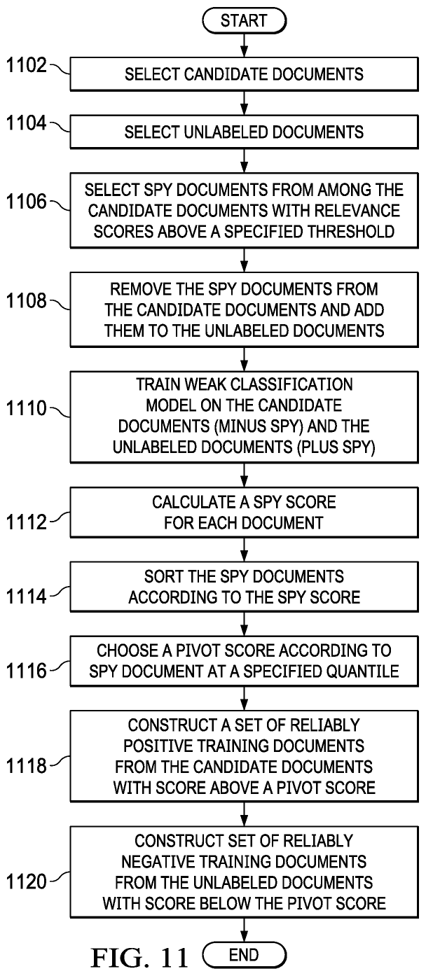

In FIG. 11, a flowchart of a process for generating training documents from candidate documents is depicted in accordance with an illustrative embodiment. The process in FIG. 11 is an example of one manner in which the use of SPY documents in FIG. 5 can be implemented. The process begins by selecting likely positive candidate documents using breadth first and depth first keyword searches (step 1102). The process also selects at random a number of unlabeled documents from a database (step 1104).

A small number of SPY documents are selected from among the likely positive candidate documents (step 1106). Standard SPY methods assume positive documents are in fact positive and, accordingly, sample SPY documents randomly. However, in the present embodiment, it is unknown if the candidate documents are actually positive. Nonetheless, sampling SPY documents with a high likelihood of being positive helps to ensure that the SPY documents are most representative of true positive documents, since candidate documents that are in fact negative might be excluded by the SPY process (i.e. 508) at a later point. Therefore, preference can be given to documents that are most relevant vis-a-vis their depth first or breadth first scores (or a combination thereof). A quantile threshold (e.g., top 25%) of a relevance score with respect to the expanded set of key terms can be defined for step 1106, wherein the SPY documents are selected randomly from among candidate documents within this quantile. The percentage of the candidate documents selected as the SPY documents might range, e.g., from one to 20 percent.

The selected SPY documents are removed from the set of candidate documents and added to the set of unlabeled documents (step 1108).

The SPY process is then initiated by training a weak classification model with the candidate documents (minus SPY documents) and unlabeled documents (plus SPY documents) (step 1110). The SPY process observes predictions the weak classification model makes about known SPY documents in the set of unlabeled documents.

The weak classification model generates a SPY score for each of the candidate documents and the unlabeled documents (step 1112). The SPY score is a predicted probability that a given document is relevant to the concept in question (i.e. concept 210).

The SPY process collects all SPY documents known to be in the set of unlabeled documents and sorts them in the order of their respective SPY scores (step 1114). The SPY process then selects the L-th quantile SPY document (wherein L is predefined) and uses the SPY score for that document as a pivot score (step 1116).

A set of reliably positive documents is constructed using all candidate documents with SPY scores greater than the pivot score (step 1118). Conversely, a set of reliably negative documents is constructed from all unlabeled documents with SPY scores less than the pivot score (step 1120).

It should be noted that the steps shown in FIG. 11 need not occur in the order shown. For example, steps 1102 and 1104 might occur in reverse order or concurrently. Similarly, steps 1118 and 1120 might also be performed in reverse order or concurrently.

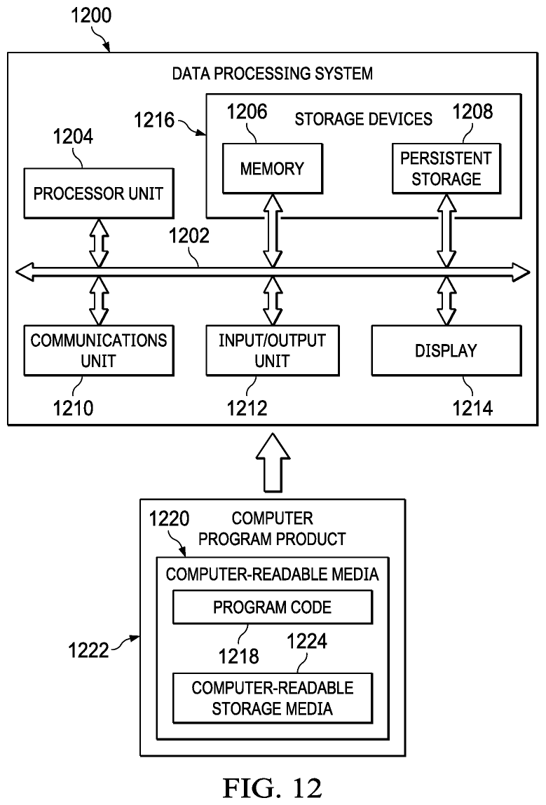

Turning now to FIG. 12, a block diagram of a data processing system is depicted in accordance with an illustrative embodiment. Data processing system 1200 can be used to implement server computer 104, server computer 106, client devices 110, in FIG. 1. Data processing system 1200 can also be used to implement computer system 206 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor.

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program code, computer usable program code, or computer-readable program code that can be read and executed by a processor in processor unit 1204. The program code in the different embodiments can be embodied on different physical or computer-readable storage media, such as memory 1206 or persistent storage 1208.

Program code 1218 is located in a functional form on computer-readable media 1220 that is selectively removable and can be loaded onto or transferred to data processing system 1200 for execution by processor unit 1204. Program code 1218 and computer-readable media 1220 form computer program product 1222 in these illustrative examples. In the illustrative example, computer-readable media 1220 is computer-readable storage media 1224.

In these illustrative examples, computer-readable storage media 1224 is a physical or tangible storage device used to store program code 1218 rather than a medium that propagates or transmits program code 1218.

Alternatively, program code 1218 can be transferred to data processing system 1200 using a computer-readable signal media. The computer-readable signal media can be, for example, a propagated data signal containing program code 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program code 1218 can be located in computer-readable media 1220 in the form of a single storage device or system. In another example, program code 1218 can be located in computer-readable media 1220 that is distributed in multiple data processing systems. In other words, some instructions in program code 1218 can be located in one data processing system while other instructions in program code 1218 can be located in one data processing system. For example, a portion of program code 1218 can be located in computer-readable media 1220 in a server computer while another portion of program code 1218 can be located in computer-readable media 1220 located in a set of client computers.

The different components illustrated for data processing system 1200 are not meant to provide architectural limitations to the manner in which different embodiments can be implemented. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program code 1218.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, memory 1206, or portions thereof, may be incorporated in processor unit 1204 in some illustrative examples.

Thus, illustrative embodiments by method, apparatus, system, and computer program product for training an artificial intelligence system to recognize a concept in a text document. In one illustrative example, ail automated process creates a training dataset comprising documents and the automated process is performed in a manner that provides an information-rich training data sample for training an artificial intelligence model. This automated process can be implemented in the illustrative example described for FIG. 2 in which concept modeling engine 202 operates to train artificial intelligence models 236.

Thus, in the illustrative examples, a greater number of training documents can be generated more quickly by the automated processes in concept modeling engine 202 in FIG. 2, as compared to the number of training documents generated by human operators. For example, the generation of hundreds of thousands of training documents and training of an artificial intelligence model using the training documents can be performed in seconds or minutes in the illustrative examples rather than hours or days using current techniques in which only hundreds of training documents are generated and used for training.

Further, in the illustrative example, the accuracy of artificial intelligence models can be improved when using concept modeling engine 202 to generate training documents and train the artificial intelligence models. This increased accuracy in artificial intelligence models 236 can occur through the ability to use larger numbers of training documents generated by concept modeling engine 202 as compared to the number of training documents used by current techniques.

Additionally, concept modeling engine 202 can use supervised machine learning to train artificial intelligence model 208 as compared to current techniques that use unsupervised machine learning. With the use of supervised machine learning, increased accuracy and performance can be achieved when training artificial intelligence models. Further, with the use of supervised machine learning to train the artificial intelligence models, the predictions made by these artificial intelligence models can be at least one of explainable or interpretable. For example, an artificial intelligence model trained using supervised machine learning can provide an answer to a question and can also provide an explanation as to why the artificial intelligence model arrived at that answer. **

Additionally, artificial intelligence models trained by concept modeling engine 202 using supervised machine learning tend to provide predictions that better align with human understandings of problems. Artificial intelligence models trained using unsupervised machine learning models may not arrive at solutions that make sense to human observers.

Further, in the illustrative example, artificial intelligence models can be trained by processing this automatically generated training data. In the illustrative example, the training of the artificial intelligence model can be performed in a manner that enables artificial intelligence models trained to cover a more diverse set of concepts and to be much larger than those created using current processes. Furth r, the training datasets generated in the illustrative examples can provide artificial intelligence models that are more accurate, robust, and able to serve a wider range or applications as compared to artificial intelligence models generated current training techniques.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for training an artificial intelligence model, the method comprising:
identifying, by a computer system, a set of key terms that relate to a concept for which training of the artificial intelligence model is of interest;
expanding, by the computer system, the set of key terms into a key term superset comprising terms that include the set of key terms and a number of additional terms that have meanings related to a number of key terms in the set of key terms;
identifying, by the computer system, candidate documents that have a selected likelihood of being relevant to the concept using the terms in the key term superset based on an occurrence of the terms in the candidate documents; and
generating, by the computer system, training documents from the candidate documents and from unlabeled documents in which the unlabeled documents have not been selected based on the unlabeled documents having a likelihood of being relevant to the concept, wherein time is reduced in training the artificial intelligence model to identify documents relating to the concept with the computer generating the training documents.

2. The method of claim 1, wherein identifying, by the computer system, the set of key terms comprises:
receiving, by the computer system, the set of key terms in a user input generated by at least one of a human machine interface or artificial intelligence system.

3. The method of claim 1, wherein expanding, by the computer system, the set of key terms into the key term superset comprising terms that include the set of key terms and the number of additional terms that have meanings related to the number of key terms in the set of key terms comprises:
expanding, by the computer system, the set of key terms into the key term superset using a synonym model, wherein the key term superset comprises the set of key terms and the number of additional terms that have the meanings related to the number of key terms in the set of key terms that are obtained from the synonym model.

4. The method of claim 3, wherein the synonym model comprises at least one of an anchor link method, a URL redirects and disambiguation method, a wikidata synonym ranking method, a word embedding, or a word vector model.

5. The method of claim 1, wherein identifying, by the computer system, candidate documents that have the selected likelihood of being relevant to the concept using the key term superset based on the occurrence of the terms in the candidate documents comprises:
identifying, by the computer system, the candidate documents from a collection of documents based on how many of the terms in the key term superset are in each document in the collection of documents to form breadth first prioritized documents and how many times a term in the key term superset is present in each document in the collection of documents to form depth first prioritized documents.

6. The method of claim 5, wherein, by the computer system, identifying the candidate documents from the collection of documents based on how many of the terms in the key term superset are in each document in the collection of documents to form the breadth first prioritized documents and how many times the term in the key term superset is present in each document in the collection of documents to form depth the first prioritized documents comprises:
identifying, by the computer system, the candidate documents from the collection of documents using a first threshold of how many different terms in the key term superset are present in each document in the collection of documents to form the breadth first prioritized documents and a second threshold of how many times a term in the key term superset is present in each document in the collection of documents to form the depth first prioritized documents.

7. The method of claim 1, wherein identifying, by the computer system, candidate documents that have the selected likelihood of being relevant to the concept using the key term superset based on the occurrence of the terms in the candidate documents comprises:
prioritizing, by the computer system, a collection of documents based on the occurrence of the terms in the documents to form depth first prioritized documents; and
identifying, by the computer system, the candidate documents based on a number of prioritized documents having a priority level that indicates the likelihood of being relevant to the concept.

8. The method of claim 7, wherein prioritizing, by the computer system, the documents based on the occurrence of the terms in the documents comprises:
prioritizing, by the computer system, the documents based on how many different terms in the key term superset are in each document in the documents to form breadth first prioritized documents; and
prioritizing, by the computer system, the documents based on how many times a term in the key term superset is present in each document in the documents to form depth first prioritized documents, wherein the documents having a higher priority have a higher likelihood of being relevant to the concept as compared to the documents having a lower priority.

9. The method of claim 8, wherein generating, by the computer system, the training documents from the candidate documents and from the unlabeled documents that have not been selected based on the unlabeled documents having the likelihood of being relevant to the concept comprises:
selecting, by the computer system, a number of the breadth first prioritized documents and a number of the depth first prioritized documents having a highest priority level; and
randomly selecting, by the computer system, a number of the unlabeled documents that have not been selected based on the unlabeled documents having the likelihood of being relevant to the concept; and.
combining, by the computer system, the number of the breadth first prioritized documents and the number of the depth first prioritized documents having a highest priority level with the number of unlabeled documents to form the training documents to form the training documents with binary labels.

10. The method of claim 9, wherein a document in the breadth first prioritized documents is also in the number of the depth first prioritized documents.

11. The method of claim 1, wherein generating, by the computer system, the training documents from the candidate documents and from unlabeled documents that have not been selected base on the likelihood of being relevant to the concept comprises:
generating, by the computer system, the training documents from the candidate documents and from unlabeled documents that have not been selected based on the unlabeled documents having the likelihood of being relevant to the concept using a set of machine learning algorithms.

12. The method of claim 11, wherein the set of machine learning algorithms comprises at least one of an Expectation-Maximization algorithm, a SPY algorithm, a partially supervised classifier, a weakly supervised classifier, a semi-supervised classifier, a positive-unlabeled classifier, a bag-of-words model, a term frequency model-inverse document frequency (tf-idf) vectorization, a Naive Bayes classifier, a Complement Naive Bayes classifier, a Logistic Regression classifier, an artificial neural network classifier, a random forest classifier, a support vector machine classifier, or a distributed word embedding.

13. The method of claim 1, wherein generating, by the computer system, the training documents from the candidate documents and from unlabeled documents that have not been selected base on the likelihood of being relevant to the concept comprises:
selecting, by the computer system, a number of SPY documents from among the candidate documents;
removing, by the computer system, the selected SPY documents from the candidate documents;
adding, by the computer system, the selected SPY documents to the unlabeled documents;
training, by the computer system, a weak classification model with the candidate documents and unlabeled documents, wherein the unlabeled documents include the SPY documents;
calculating, by the computer system with the weak classification model, a SPY score for each candidate document and unlabeled document;
sorting, by the computer system, the SPY documents in order of respective SPY score;
selecting, by the computer system, a pivot SPY document at a specified quantile of the SPY documents, wherein the SPY score of the pivot document constitutes a pivot score;
constructing, by the computer system, a set of reliably positive documents from all candidate documents with SPY scores greater than the pivot score; and
constructing, by the computer system, a set of reliably negative documents from all unlabeled documents with SPY scores less than the pivot score.

14. The method of claim 13, wherein the SPY documents are selected from among candidate documents having relevance scores within a specified quantile.

15. The method of claim 1 further comprising:
training, by the computer system, the artificial intelligence model using the training documents to create a text classifier.

16. The method of claim 15 further comprising:
classifying, by the computer system, documents using the text classifier trained using the training documents.

17. A method for training an artificial intelligence model, the method comprising:
identifying, by a computer system, a set of key terms that relate to a concept for which training of the artificial intelligence model is of interest;
expanding, by the computer system, the set of key terms into a key term superset comprising terms that include the set of key terms and number of additional terms that have meanings related to a number of key terms in the set of key terms;
searching, by the computer system, a collection of documents using the terms in the key term superset to identify unlabeled documents in which the unlabeled documents have not been selected based on the unlabeled documents having a likelihood of being relevant to the concept; and
generating, by the computer system, training documents from the unlabeled documents using a machine learning model, wherein the training documents comprises a positive sample and a negative sample, wherein the positive sample comprises documents in the unlabeled documents that have been prioritized based on a presence of terms in the documents and the negative sample comprises a random sampling of unlabeled documents from the collection of documents, wherein the method enables reducing a time in training the artificial intelligence model to identify documents relating to the concept by the computer system generating the training documents.

18. A concept recognition system comprising:
a computer system; and
a concept modeling engine in the computer system, wherein the concept modeling engine operates to:
identify a set of key terms that relate to a concept for which training of an artificial intelligence model is of interest;
expand the set of key terms into a key term superset comprising terms that include the set of key terms and a number of additional terms that have meanings related to a number of key terms in the set of key terms;
identify candidate documents that have a selected likelihood of being relevant to the concept using the terms in the key term superset based on an occurrence of the terms in the candidate documents; and
generate training documents from the candidate documents and from unlabeled documents in which the unlabeled documents have not been selected based on the unlabeled documents having a likelihood of being relevant to the concept, wherein time is reduced in training the artificial intelligence model to identify documents relating to the concept with the computer generating the training documents.

19. The concept recognition system of claim 18, wherein in identifying the set of key terms, the concept modeling engine operates to:
receive the set of key terms in a user input generated by at least one of a human machine interface or artificial intelligence system.

20. The concept recognition system of claim 18, wherein in expanding the set of key terms into the key term superset comprising terms that include the set of key terms and the number of additional terms that have the meanings related to the set of key terms, the concept modeling engine operates to:
expand the set of key terms into the key term superset using a synonym model, wherein the key term superset comprises the set of key terms and the number of additional terms that have the meanings related to the number of terms in the set of key terms that are obtained from the synonym model.

21. The concept recognition system of claim 20, wherein the synonym model comprises at least one of an anchor link method, a URL redirects and disambiguation method, a wikidata synonym ranking method, a word embedding, or a word vector model.

22. The concept recognition system of claim 18, wherein in identifying candidate documents that have the selected likelihood of being relevant to the concept using the key term superset based on the occurrence of the terms in the candidate documents, concept modeling engine operates to: identify the candidate documents from a collection of documents based on how many of the terms in the key term superset are in each document in the collection of documents to form breadth first prioritized documents and how many times a term in the key term superset is present in each document in the collection of documents to form depth first prioritized documents.

23. The concept recognition system of claim 22, wherein, by the computer system, in identifying the candidate documents from the collection of documents based on how many of the terms in the key term superset are in each document in the collection of documents to form the breadth first prioritized documents and how many times the term in the key term superset is present in each document in the collection of documents to form depth the first prioritized documents, concept modeling engine operates to:
identify the candidate documents from the collection of documents using a first threshold of how many different terms in the key term superset are present in each document in the collection of documents to form the breadth first prioritized documents and a second threshold of how many times a term in the key term superset is present in each document in the collection of documents to form the depth first prioritized documents.

24. The concept recognition system of claim 18, wherein in identifying candidate documents that have the selected likelihood of being relevant to the concept using the key term superset based on the occurrence of the terms in the candidate documents, the concept modeling engine operates to:
prioritize documents based on the occurrence of the terms in the documents to form depth first prioritized documents; and
identify the candidate documents based on a number of prioritized documents having a priority level that indicates the likelihood of being relevant to the concept.

25. The concept recognition system of claim 24, wherein in prioritizing the documents based on the occurrence of the terms in the documents, the concept modeling engine operates to:
prioritize the documents based on how many different terms in the key term superset are in each document in the documents to form breadth first prioritized documents; and
prioritize the documents based on how many times a term in the key term superset is present in each document in the documents to form depth first prioritized documents, wherein the documents having a higher priority have a higher likelihood of being relevant to the concept as compared to the documents having a lower priority.

26. The concept recognition system of claim 25, wherein in generating the training documents from the candidate documents and from unlabeled documents that have not been selected based on the unlabeled documents having the likelihood of being relevant to the concept, the concept modeling engine operates to:
select a number of the breadth first prioritized documents and a number of the depth first prioritized documents having a highest priority level;
randomly select a number of the unlabeled documents that have not been selected based on the unlabeled documents having the likelihood of being relevant to the concept; and
combine number of the breadth first prioritized documents and the number of the depth first prioritized documents having a highest priority level with the number of unlabeled documents to form the training documents to form the training documents with binary labels.

27. The concept recognition system of claim 26, wherein a document in the breadth first prioritized documents is also in the number of the depth first prioritized documents.

28. The concept recognition system of claim 18, wherein in generating the training documents from the candidate documents and from unlabeled documents that have not been selected based on the unlabeled documents having the likelihood of being relevant to the concept, the concept modeling engine operates to:
generate the training documents from the candidate documents and from unlabeled documents that have not been selected based on the unlabeled documents having the likelihood of being relevant to the concept using a set of machine learning algorithms.

29. The concept recognition system of claim 28, wherein the set of machine learning algorithms comprises at least one of an Expectation-Maximization algorithm, a SPY algorithm, a partially supervised classifier, a weakly supervised classifier, a semi-supervised classifier, a positive-unlabeled classifier, a bag-of-words model, a term frequency model-inverse document frequency (tf-idf) vectorization, a Naive Bayes classifier, a Complement Naive Bayes classifier, a Logistic Regression classifier, an artificial neural network classifier, a random forest classifier, a support vector machine classifier, or a distributed word embedding.

30. The concept recognition system of claim 18, wherein in generating the training documents from the candidate documents and from unlabeled documents that have not been selected based on the likelihood of the unlabeled documents being relevant to the concept, the concept modeling engine operates to:
select a number of SPY documents from among the candidate documents;
remove the selected SPY documents from the candidate documents;
add the selected SPY documents to the unlabeled documents;
train a weak classification model with the candidate documents and unlabeled documents, wherein the unlabeled documents include the SPY documents;
calculate, with the weak classification model, a SPY score for each candidate document and unlabeled document;
sort the SPY documents in order of respective SPY score;
select a pivot SPY document at a specified quantile of the SPY documents, wherein the SPY score of the pivot document constitutes a pivot score;
construct a set of reliably positive documents from all candidate documents with SPY scores greater than the pivot score; and
construct a set of reliably negative documents from all unlabeled documents with SPY scores less than the pivot score.

31. The concept recognition system of claim 30, wherein the SPY documents are selected from among candidate documents having relevance scores within a specified quantile.

32. The concept recognition system of claim 18, wherein the concept modeling engine operates to:
train the artificial intelligence model using the training documents to create a text classifier.

33. The concept recognition system of claim 32 further comprising:
classifying, by the computer system, documents using the text classifier trained using the training documents.

34. A concept recognition system comprising:
a computer system that operates to:
identify a set of key terms that relate to a concept for which training of the artificial intelligence model is of interest;
expand the set of key terms into a key term superset comprising terms that include the set of key terms and number of additional terms that have meanings related to a number of key terms in the set of key terms;
search a collection of documents using the terms in the key term superset to identify unlabeled documents in which the unlabeled documents that have not been selected based on the unlabeled documents having a likelihood of being relevant to the concept; and
generate training documents from the unlabeled documents using a machine learning model, wherein the training documents comprises a positive sample and a negative sample, wherein the positive sample comprises documents in the unlabeled documents that have been prioritized based on a presence of terms in the documents and the negative sample comprises a random sampling of unlabeled documents from the collection of documents, wherein the concept recognition system enables reducing time in training the artificial intelligence model to identify documents relating to the concept with the computer generating the training documents.

35. A computer program product for training an artificial intelligence model, the computer program product comprising:
a computer readable storage media;
first program code, stored on the computer readable storage media, for identifying a set of key terms that relate to a concept for which training of the artificial intelligence model is of interest;
second program code, stored on the computer readable storage media, for expanding the set of key terms into a key term superset comprising terms that include the set of key terms and a number of additional terms that have meanings related to a number of key terms in the set of key terms;
third program code, stored on the computer readable storage media, for identifying candidate documents that have a selected likelihood of being relevant to the concept using the terms in the key term superset based on an occurrence of the terms in the candidate documents; and
fourth program code, stored on the computer readable storage media, for generating training documents from the candidate documents and from unlabeled documents in which the unlabeled documents have not been selected based on the unlabeled documents having a likelihood of being relevant to the concept, wherein time is reduced in training the artificial intelligence model to identify documents relating to the concept with the computer generating the training documents.

36. The computer program product of claim 35, wherein third program code comprises:
program code, stored on the computer readable storage media, for receiving the set of key terms in a user input generated by at least one of a human machine interface or artificial intelligence system.

37. The computer program product of claim 35, wherein second program code comprises:
program code, stored on the computer readable storage media, for expanding the set of key terms into the key term superset using a synonym model, wherein the key term superset comprises the set of key terms and the number of additional terms that have the meanings related to the number of terms in the set of key terms that are obtained from the synonym model.

38. The computer program product of claim 37, wherein the synonym model comprises at least one of an anchor link method, a URL redirects and disambiguation method, a wikidata synonym ranking method, a word embedding, or a word vector model.

39. The computer program product of claim 35, wherein third program code comprises:
program code, stored on the computer readable storage media, for identifying the candidate documents from a collection of documents based on how many of the terms in the key term superset are in each document in the collection of documents to form breadth first prioritized documents and how many times a term in the key term superset is present in each document in the collection of documents to form depth first prioritized documents.

40. The computer program product of claim 39 wherein the third program code comprises:
program code, stored on the computer readable storage media, for identifying the candidate documents from the collection of documents using a first threshold of how many different terms in the key term superset are present in each document in the collection of documents to form the breadth first prioritized documents and a second threshold of how many times a term in the key term superset is present in each document in the collection of documents to form the depth first prioritized documents.

41. The computer program product of claim 35, wherein the fourth program code comprises:
program code, stored on the computer readable storage media, for generating the training documents from the candidate documents and from unlabeled documents that have not been selected based on the unlabeled documents having the likelihood of being relevant to the concept using a set of machine learning algorithms.

42. The computer program product of claim 41, wherein the set of machine learning algorithms comprises at least one of an Expectation-Maximization algorithm, a SPY algorithm, a partially supervised classifier, a weakly supervised classifier, a semi-supervised classifier, a positive-unlabeled classifier, a bag-of-words model, a term frequency model-inverse document frequency (tf-idf) vectorization, a Naive Bayes classifier, a Complement Naive Bayes classifier, a Logistic Regression classifier, an artificial neural network classifier, a random forest classifier, a support vector machine classifier, or a distributed word embedding.

43. The computer program product of claim 35, wherein the fourth program code comprises:
program code, stored on the computer readable storage media, for:
selecting a number of SPY documents from among the candidate documents;
removing the selected SPY documents from the candidate documents;
adding the selected SPY documents to the unlabeled documents;
training a weak classification model with the candidate documents and unlabeled documents, wherein the unlabeled documents include the SPY documents;
calculating, with the weak classification model, a SPY score for each candidate document and unlabeled document;
sorting the SPY documents in order of respective SPY score;
selecting a pivot SPY document at a specified quantile of the SPY documents, wherein the SPY score of the pivot document constitutes a pivot score;
constructing a set of reliably positive documents from all candidate documents with SPY scores greater than the pivot score; and
constructing a set of reliably negative documents from all unlabeled documents with SPY scores less than the pivot score.

44. The computer program product of claim 43, wherein the SPY documents are selected from among candidate documents having relevance scores within a specified quantile.
